(19) United States
(12) Patent Application Publication
(10) Pub. No.: US 2008/0199589 A1
(43) Pub. Date: Aug. 21, 2008

(54) Lipid Microemulsions

(75) Inventors: Alexander Patist, Shakopee, MN (US); Melanie J. Goulson, Dayton, MN (US); Wade N. Schmelzer, St. Louis Park, MN (US); John F. Sweeney, St. Michael, MN (US); Robert D. Olson, Eden Prairie, MN (US); Vincent M. Cavallini, Shakopee, MN (US)

Correspondence Address: FISH & RICHARDSON P.C., PO BOX 1022, MINNEAPOLIS, MN, 55440-1022, US

(73) Assignee: Cargill, Incorporated, Wayzata, MN (US)

(21) Appl. No.: 11/676,955

(22) Filed: Feb. 20, 2007

(51) Int. Cl. A23D 7/00

(52) U.S. Cl. 426/602; 516/72

(57) ABSTRACT

A microemulsion, including an aqueous component, a lipid, a saccharide, an alcohol, and an emulsifier is described. A process for producing a microemulsion is also described. Food or beverage products including a microemulsion are also described.

### TECHNICAL FIELD

This invention relates to lipid microemulsions.

### BACKGROUND

A number of lipids have been identified as providing positive health benefits. For example, sterol esters and stanol esters are known to reduce cholesterol and to reduce the risk of cardiovascular disease. Omega-3 fatty acids, particularly eicosapentaenoic acid (EPA) and docosahexaenoic acid (DHA), also have positive health and cardiovascular benefits.

Attempts have been made to incorporate lipid materials into various food products. The incorporation into food products that contain a high concentration of fats and oils has generally been accomplished with little adverse sensory impact. However, the health impact of such incorporation is often mixed as these food products generally have a high level of unhealthy fats and oils. Attempts to incorporate these materials into aqueous systems, such as beverages, have been less successful. Frequently, the lipid materials visibly separate from the remainder of the composition. In addition to the poor aesthetic appearance, the composition may leave residue in containers and glasses, and may have a chalky or powdery texture or mouthfeel, or other undesirable taste effects.

### SUMMARY

A microemulsion may be formed that includes aqueous and lipid components. These microemulsions may be added to products, such as beverages, to disperse the lipid components throughout the product. Microemulsions are clear, isotropic liquid mixtures of oil, water, and a surfactant. In contrast to ordinary emulsions, microemulsions form upon simple mixing of the components and do not require high shear conditions. The stability created by the microemulsion enables simplified production and processing of products under some conditions.

Sterols can be derived from a variety of plant sources, including rice bran oil, corn fiber oil, corn germ oil, wheat germ oil, sunflower oil, safflower oil, oat oil, olive oil, cotton seed oil, soybean oil, peanut oil, canola oil, tea, sesame seed oil, grapeseed oil, rapeseed oil, linseed oil, tall oil and other oils obtained from wood pulp, other plant sources such as Mexican yam, olives, or sugar cane, and various brassica crops. Although plant sterols are typically derived from plants, a plant sterol can also be synthetically prepared, e.g., it need not be derived from a plant source. Additionally, plant sterols can be prepared as mixtures of individual purified or synthesized plant sterol compounds or can be co-products resulting from purifications of other products (e.g., from plant sources). For example, a plant sterol can be obtained as a co-product of the manufacture of vitamin E and/or tocopherols from vegetable oil deodorizer distillate. Examples of specific sterols include sitosterol, campesterol, stigmasterol, brassicasterol, avenasterol, and diosgenin. Examples of specific stanols, which are hydrogenated forms of sterols, include sitostanol and campestanol.

Sterols and mixtures of sterols may be esterified, using a variety of processes, to form sterol esters. Similarly, stanols or mixtures of stanols may be esterified to form stanol esters. In some cases, sterol esters may be hydrogenated to form stanol esters.

All percentages (%) used herein, unless otherwise stated, are on a % weight basis.

In one aspect, a microemulsion is described that includes an aqueous liquid, a lipid selected from the group consisting of sterol esters, stanol esters, Omega-3 fatty acids, and mixtures thereof, a saccharide, an alcohol, and a first emulsifier. The aqueous liquid may be present in the microemulsion in a concentration of 50 wt % or less, or 33 wt % or less. The aqueous liquid may be present in the microemulsion in a concentration of 75 wt % or greater, or 90 wt % or greater. The lipid may include one or more Omega-3 fatty acids. The microemulsion may also include a harmonizer, an anti-oxidant, or a second emulsifier. The microemulsion may be clear. The microemulsion may be haze-free.

The lipid may be present in the microemulsion in a concentration of 1.0 wt % or more. The lipid may include Omega-3 fatty acids, and the lipid may be present in the microemulsion in a concentration of about 0.44 wt % or more. The lipid may include sterol esters, stanol esters, or combinations thereof, and the lipid may present in the microemulsion in a concentration of about 0.30 wt % or more.

The ratio of lipid to the first emulsifier in the microemulsion may be 0.2:1 or greater, or 0.5:1 or greater. The microemulsion may include lipid including Omega-3 fatty acids, and the ratio of lipid to the first emulsifier in the microemulsion may be 0.2:1 or greater. The microemulsion may include lipid including sterol esters, stanol esters, or combinations thereof, and the ratio of lipid to the first emulsifier in the microemulsion may be 0.5:1 or greater.

The saccharide may be present in the microemulsion in a concentration of 1.0 wt % or more. The saccharide may include one or more disaccharides, or may be selected from the group consisting of sucrose, trehalose, fructose, and mixtures thereof. The first emulsifier may include a mixture of mono- and di-glycerides, or a mixture of ethoxylated mono- and di-glycerides, and may be present in the microemulsion in a concentration of 1.0 wt % or more. The alcohol may include ethanol, or glycerol, and may be present in the microemulsion in a concentration of 1.0 wt % or more.

In another aspect, a process for forming a microemulsion is described that includes adding a saccharide to an aqueous liquid to form a mixture, adding an alcohol to the mixture, adding an emulsifier to the mixture, and adding a lipid to the mixture to form a microemulsion. The lipid may be added after all the other components. The process may also include adding a harmonizer or anti-oxidant to the mixture. Adding an emulsifier may include adding a combination of a first emulsifier and a second emulsifier to the mixture. The microemulsion may be formed without the use of a homogenizer or sonic bath.

In another aspect, a process for producing a product including a microemulsion is described that includes forming a microemulsion including an aqueous liquid, a lipid, a saccharide, an alcohol, and an emulsifier, and adding the microemulsion to the product. The product may be a food product, a beverage, or a cosmetics product.

In another aspect, a food or beverage product including a microemulsion is described, wherein the microemulsion includes an aqueous liquid, a lipid selected from the group consisting of sterol esters, stanol esters, Omega-3 fatty acids, and mixtures thereof, a saccharide, an alcohol, and a first emulsifier. The food or beverage product may also include a harmonizer, an anti-oxidant, or a second emulsifier.

The lipid may include Omega-3 fatty acids, and may be present in the food or beverage product at a concentration of 0.44 wt % or greater. The lipid may include one or more sterol esters, and may present in the food or beverage product at a concentration of 0.3 wt % or greater. The lipid may include one or more stanol esters, and may be present in the food or beverage product at a concentration of 0.3 wt % or greater.

The details of one or more embodiments of the invention are set forth in the description below. Other features, objects, and advantages of the invention will be apparent from the description and from the claims.

### DETAILED DESCRIPTION

Microemulsion compositions can enable the incorporation of lipids into aqueous-based products, including foods and beverages. The resulting products have good sensory qualities, including typical product texture, lack of grittiness, and minimal waxiness. Foods and beverages incorporating the microemulsion generally exhibit a texture typically equivalent to the food or beverage lacking the microemulsion, have a clean mouthfeel, and do not exhibit the waxy or mouthcoating characteristics typical of lipids in aqueous mixtures. As the microemulsion is thermodynamically stable, the product incorporating the microemulsion remains stable over an extended period of time is 5A microemulsion may be formed that includes an aqueous component, a lipid component, a primary emulsifier, an alcohol, and a saccharide. In various embodiments, one or more components of each type may be included in the microemulsion. In addition, other optional components, such as secondary emulsifiers, harmonizers, and anti-oxidants, can be added.

The aqueous component of the microemulsion may consist only of water, or may include liquids incorporating water such as juice, tea, milk, coffee, or other liquid. The presence of an aqueous component enables and improves the incorporation of the microemulsion into a variety of aqueous-based products.

Lipids include a variety of organic, hydrocarbon-based molecules that are predominantly nonpolar or hydrophobic, but also typically have some polar or hydrophilic character. This makes them amphipathic or amphiphilic molecules (having both hydrophobic and hydrophilic portions). The lipid component of the microemulsion can include one or more lipids. Examples of lipids that may be used in forming microemulsions include sterol esters, stanol esters, and Omega-3 fatty acids, particularly eicosapentaenoic acid (EPA) and docosahexaenoic acid (DHA). The presence of the lipid component generally brings a desirable health benefit with usage of the microemulsion. Omega-3 fatty acids, such as EPA and DHA, are typically found in fish, and are generally available in fish products, such as fish oil.

The microemulsion includes a primary emulsifier (or surfactant) component. The primary emulsifier can promote the thermodynamic stability of the microemulsion by generating an ultra-low free energy per unit of interfacial area between the oil and water domains in the solution. In one embodiment, the primary emulsifier includes one or more ethoxylated mono/diglycerides. Examples of suitable ethoxylated mono/diglycerides include those from the Mazol product line (available from BASF, Florham Park, N.J.), such as Mazol 80 MG Emulsifier.

The microemulsion includes an alcohol component. The alcohol may assist in the formation and stability of the microemulsion, as it has one or more available hydroxyl groups. Examples of suitable alcohols include ethanol and glycerol. In one embodiment, one or more alcohols may be present.

The microemulsion includes a saccharide. Various saccharides may be used, including monosaccharides, disaccharides, or a mixture of saccharides. In one embodiment, a disaccharide is used. Examples of suitable disaccharides include sucrose and trehalose. In one embodiment, one or more saccharides may be present.

Optionally, the microemulsion may include additional components.

In one embodiment, the microemulsion may include one or more secondary emulsifiers (or surfactants) as an additional component. Secondary emulsifiers can assist in forming the microemulsion. Secondary emulsifiers include glycerides, modified glycerides, and modified glycerols. Examples of suitable secondary emulsifiers include Polyglycerol Polyrcinoleate (“PGPR”), and Polyglycerol Esters of Fatty Acids or PolyGlycerol Ester (“PGE”).

In one embodiment, the microemulsion may include one or more harmonizers as an additional component. Harmonizers may act to reduce the haze or translucent character of the microemulsion. They may also act as a type of surfactant. Examples of harmonizers that can be used as additional components include Duckworth's flavor enhancer (available from Cargill Inc.), Tween 60 & Tween 80 (available from ICI America), and sucrose esters. The harmonizer may be selected based on the food environment in which the microemulsion will be used. For example, sucrose esters are generally not stable in an acidic environment, and therefore may not be the optimal choice as a harmonizer for a microemulsion to be used in a carbonated (acidic) beverage. The use of a harmonizer may enable a reduction in the amount of emulsifier necessary for a microemulsion.

In one embodiment, the microemulsion may include one or more anti-oxidants as an additional component. Anti-oxidants may act to prevent the oxidation and/or degradation of the lipid components of the microemulsion. Oxidation of the lipid components may lead to the generation of off-flavor or off-color components in the microemulsion. Examples of anti-oxidants that may be added include vitamin E.

The components may be combined together in various combinations and amounts to form microemulsions. For example, microemulsions can be formed having a wide range of aqueous content, and various microemulsion concentrates as well as dilute microemulsions can be formed.

Forming a microemulsion typically requires a high ratio of surfactant or emulsifier compared with the amount of hydrophilic components used. This can result in several problems. For example, there are limits set by the FDA and other agencies relating the amount of emulsifiers/surfactants that may be present in food products. In addition, the large amount of emulsifiers required to stabilize the microemulsion may reduce the amount of lipid material present in the microemulsion. This can make it difficult to add a significant or sufficient amount of lipids to products through the use of a microemulsion. However, it has been found that a saccharide may be incorporated into a microemulsion to improve the stability of the microemulsion, enabling the amount of emulsifier to be reduced, or the relative amount of lipids in the microemulsion to be increased. In various embodiments, the ratio of lipid to primary emulsifier can be 0.1:1 or higher, 0.2:1 or higher, 0.33:1 or higher, 0.5:1 or higher, 0.6:1 or higher, 0.7:1 or higher, or 0.75:1 or higher.

In one embodiment, a microemulsion may be formed that includes Omega-3 fatty acids, and has a ratio of lipid to primary emulsifier of about 0.2:1 or greater. In one embodiment, a microemulsion may be formed that includes sterol esters, stanol esters, or combinations thereof, and has a ratio of lipid to primary emulsifier of about 0.5:1 or greater.

In one embodiment, a microemulsion concentrate may be formed. Generally, the amount of aqueous liquid present in a microemulsion concentrate composition can be less than or equal to 50%. In various embodiments, the amount of aqueous liquid present in the microemulsion concentrate composition may be less than about 40%, less than about 33%, less than 25%, or less than about 20%.

In various possible microemulsion concentrates, the lipid component may be present in an amount greater than or equal to 1%, 2%, 3%, 5%, 8%, 10%, or 12%. The lipid component may be present in an amount equal to or less than 33%, 30%, 25%, 20%, or 15%. In various possible microemulsion concentrates, the primary emulsifier may be present in an amount greater than or equal to 1%, 5%, 10%, 12%, 15%, or 20%. The primary emulsifier may be present in an amount equal to or less than 40%, 35%, 33%, 30%, or 25%. In various possible microemulsion concentrates, the alcohol component is (including one or more alcohols) may be present in an amount greater than or equal to 1%, 5%, 8%, 10%, or 12%. The alcohol component may be present in an amount equal to or less than 33%, 30%, 25%, 20%, or 15%. In various possible microemulsion concentrates, the saccharide component (including one or more saccharides) may be present in an amount greater than or equal to 1%, 5%, 10%, 12%, 15%, or 17%. The saccharide components may be present in an amount equal to or less than 33%, 30%, 25%, 22%, or 20%.

When forming a dilute microemulsion composition, the amount of aqueous component will increase, and the amount of other components will decrease, compared to a microemulsion concentrate. The amount of aqueous liquid present in a dilute microemulsion may be greater than 50%. In various embodiments the amount of aqueous liquid in the composition may be greater than 67%, greater than 75%, greater than 85%, greater than 90%, or greater than 95%.

In one embodiment, a product including a microemulsion may be formed that includes Omega-3 fatty acids at a concentration of about 0.44 wt % or greater. In one embodiment, a product including a microemulsion may be formed that includes sterol esters, stanol esters, or combinations thereof at a concentration of about 0.30 wt % or greater.

A microemulsion can be formed by adding the various components together. The components may be added together in a sequential fashion, added together at one time, by adding combinations of components together, or in some other fashion. In one embodiment, the components are added in the following order: aqueous component, disaccharide component, alcohol component, primary emulsifier, secondary emulsifier, lipid component, and then other optional components. In one embodiment, the primary and secondary emulsifiers are mixed together prior to addition to the other components. In one embodiment, all of the components (except the lipid component) are added together prior to addition of the lipid component.

The addition of components may be accompanied by agitation or stirring. For example, the components may be added with continuous stirring, by stirring only upon addition of each component, or with minimal stirring. The processing of the microemulsion does not require using additional equipment, such as using a homogenizer or ultrasonic bath.

The microemulsion may be formed in a concentrate form. The concentrate may then be added to other products, such as foods or beverages to form a product having a final microemulsion content. Incorporation of the microemulsion into a product achieves the desired health objectives while maintaining the typical appearance and properties of the original product.

The microemulsion may be combined with the product in various ways. For example, the microemulsion may be added slowly to the product with mixing, added rapidly to the product with mixing, added dropwise to the product, or added into the product and allowed to disperse and mix together over time.

The microemulsion may be added directly to a product as the microemulsion is formed, or the microemulsion may be produced and stored for later addition to a product. As the microemulsion formed is thermodynamically stable, a later addition may include significant time and/or distance from the location where the microemulsion was formed.

The microemulsion compositions may be used in a variety of products and may provide a variety of benefits.

Incorporation of the microemulsion into a food or beverage product can maintain the positive sensory impact of the original food or beverage product while improving the health benefits of that product. Examples of suitable food applications for use of the microemulsion compositions include yogurt, dairy products such as ice cream and cheese, bars, spreads, sauces, dressings, confections, icing, toppings, baked goods, frozen confections, frozen desserts, frozen novelties, and the like. Examples of beverage products that are suitable for use of the microemulsion compositions include sports drinks, dairy drinks, carbonated beverages, teas, coffees, juices and juice drinks, and water beverages including flavored waters and near-waters.

Similarly, incorporation of the microemulsion into a product, such as a lotion, can enable full incorporation of the microemulsion into the product via the aqueous component, while additional beneficial effects are achieved by the presence of the lipid. Examples of non-food products in which the microemulsion composition may be used include cosmetics, lotions, creams, etc.

As the microemulsion is stable, it can remain dispersed in the product for a long time without separating, coating the walls of the container, or agglomerating. This characteristic preserves the appearance and sensory attributes of the product over time.

### EXAMPLES

### Example 1

### Microemulsion Concentrate Compositions

Two concentrate compositions (1A & 1B) were made using the formula as shown in Table 1, according to the following procedure: (% by weight)

1. Sucrose was added to the water and mixed until dissolved.

2. Glycerol was added to the mixture and mixed.

3. The emulsifier(s) (PGE 10-1-O, PGPR, Mazol 80 MG) were added to the mixture and mixed.

4. The sterol esters were added to the mixture with continuous stirring.

A microemulsion was formed immediately upon addition and mixing of the sterol esters without requiring additional high-shear processing steps such as using a homogenizer or ultrasonic bath. The concentrate may be added drop-wise to liquids, such as water, near water, or juice, without disrupting the microemulsion and separating the sterol esters.

TABLE 1
Concentrate Compositions

| | 1A | 1B | 1C |
|---|---|---|---|
| Water | 31.49% | 31.68% | 31.87% |
| Sucrose | 19.28% | 19.09% | 19.12% |
| Glycerol | 13.23% | 12.91% | 12.71% |
| PGE 10-1-O | 4.57% | | |
| PGPR | | 4.51% | |
| Mazol 80 MG | 17.98% | 18.23% | 22.63% |
| Sterol esters | 13.44% | 13.58% | 13.66% |
| Total | 100% | 100% | 100% |

### Example 2

### Beverage Including Microemulsion of Sterol Ester

Beverages were produced using the concentrate compositions of Example 1. These beverage mixtures were formed based on the primary ingredients for a near-water beverage.

Beverage 2A was produced by adding 2.17 grams of concentrate 1A dropwise to an aqueous solution formed by mixing 94.13 grams water and 3.58 grams sucrose. Beverage 2B was produced by adding 2.2 grams of concentrate 1B dropwise to an aqueous solution formed by mixing 94.34 grams water and 3.56 grams sucrose. Beverage 2C was formed by adding 2.20 g of Concentrate 1C dropwise to a mixture of 3.58 g sucrose in 94.23 g water.

Flavors and colorants may be added as desired to form a variety of other near-water beverages. The final near-water beverage compositions are shown in Table 2.

TABLE 2
Near-Water Beverage Compositions

| | 2A | 2B | 2C |
|---|---|---|---|
| Water | 94.93% | 94.94% | 94.92% |
| Sucrose | 4.00% | 3.98% | 4.00% |
| Glycerol | 0.29% | 0.28% | 0.28% |
| PGE 10-1-O | 0.10% | | |
| PGPR | | 0.10% | |
| Mazol 80 MG | 0.39% | 0.40% | 0.50% |
| Sterol esters | 0.29% | 0.30% | 0.30% |
| Total | 100% | 100% | 100% |

### Example 3

### Microemulsions with Fish Oil

A concentrate composition was made using the formula as shown in Table 3 (“Concentrate”), according to the following procedure:

1. Sucrose was added to the water and mixed until dissolved.

2. Glycerol was added to the mixture.

3. The emulsifier (Mazol 80 MG) was added to the mixture.

4. The fish oil was added to the mixture.

A microemulsion was formed immediately upon addition and mixing of the fish oil without requiring additional high-shear processing steps such as using a homogenizer or ultrasonic bath.

The concentrate was then used to form a beverage. 4.68 g of the Concentrate in Table 3 (“Concentrate”) was added dropwise to a mixture of 3.39 g sucrose in 91.93 g water to form a beverage having the composition as shown in Table 3 (“Beverage”).

The microemulsion formed was stable in both concentrate and beverage form, with no separation of the fish oil detected.

TABLE 3
Microemulsions including Fish Oil

| | Concentrate | Beverage |
|---|---|---|
| Water | 22.00% | 92.96% |
| Sucrose | 13.10% | 4.00% |
| Glycerol | 8.80% | 0.41% |
| Mazol 80 MG | 46.70% | 2.19% |
| Fish Oil (Denofa | 9.40% | 0.44% |
| Denomega ™ 100) | | |
| Total | 100% | 100% |

A number of embodiments of the invention have been described. Nevertheless, it will be understood that various modifications may be made without departing from the spirit and scope of the invention.

What is claimed is:

1. A microemulsion, comprising:
an aqueous liquid;
a lipid selected from the group consisting of sterol esters, stanol esters, Omega-3 fatty acids, and mixtures thereof;
a saccharide;
an alcohol; and
a first emulsifier.

2. The microemulsion of claim 1, wherein the aqueous liquid is present in the microemulsion in a concentration of 50 wt % or less.

3. The microemulsion of claim 1, wherein the aqueous liquid is present in the microemulsion in a concentration of 75 wt % or greater.

4. The microemulsion of claim 1, wherein the lipid is present in the microemulsion in a concentration of 1.0 wt % or more.

5. The microemulsion of claim 1, wherein the lipid comprises Omega-3 fatty acids, and the lipid is present in the microemulsion in a concentration of about 0.44 wt % or more.

6. The microemulsion of claim 1, wherein the lipid comprises sterol esters, stanol esters, or combinations thereof, and the lipid is present in the microemulsion in a concentration of about 0.30 wt % or more.

7. The microemulsion of claim 1, further comprising a harmonizer.

8. The microemulsion of claim 1, further comprising a second emulsifier.

9. The microemulsion of claim 1, wherein the lipid comprises Omega-3 fatty acids, and the ratio of lipid to the first emulsifier in the microemulsion is 0.2:1 or greater.

10. The microemulsion of claim 1, wherein the lipid comprises sterol esters, stanol esters, or combinations thereof, and the ratio of lipid to the first emulsifier in the microemulsion is 0.5:1 or greater.

11. A process for forming a microemulsion, comprising:
adding a saccharide to an aqueous liquid to form a mixture;
adding an alcohol to the mixture;
adding an emulsifier to the mixture; and
adding a lipid to the mixture to form a microemulsion.

12. The process of claim 11, wherein the microemulsion is formed without the use of a homogenizer or sonic bath.

13. A process for producing a product including a microemulsion, comprising:
forming a microemulsion including an aqueous liquid, a lipid, a saccharide, an alcohol, and an emulsifier; and
adding the microemulsion to the product.

14. The process of claim 13, wherein the product is a food product.

15. The process of claim 13, wherein the product is a beverage.

16. The process of claim 13, wherein the product is a cosmetics product.

17. A food or beverage product including the microemulsion of claim 1.

18. The food or beverage product of claim 17, wherein the lipid comprises Omega-3 fatty acids, and is present in the food or beverage product at a concentration of 0.44 wt % or greater.

19. The food or beverage product of claim 17, wherein the lipid comprises one or more sterol esters, and is present in the food or beverage product at a concentration of 0.3 wt % or greater.

20. The food or beverage product of claim 17, wherein the lipid comprises one or more stanol esters, and is present in the food or beverage product at a concentration of 0.3 wt % or greater.
